(19) United States
(12) Patent Application Publication
(10) Pub. No.: US 2011/0320381 A1
(43) Pub. Date: Dec. 29, 2011

(54) BUSINESS DRIVEN COMBINATION OF SERVICE ORIENTED ARCHITECTURE IMPLEMENTATIONS

(75) Inventors: Biplav Srivastava, Noida (IN); Pietro Mazzoleni, New York City, NY (US)

(73) Assignee: INTERNATIONAL BUSINESS MACHINES CORPORATION, Armonk, NY (US)

(21) Appl. No.: 12/822,758

(22) Filed: Jun. 24, 2010

(51) Int. Cl. G06Q 10/00; G06Q 50/00

(52) U.S. Cl. 705/348

(57) ABSTRACT

Systems, methods, apparatuses and program products configured to provide information technology (IT) system combination strategies are described. An explicit model of business to IT dependency is described and utilized by the systems and methods described to expose trade-offs in different combination alternatives, thus assisting in making proactive choices regarding business combination of disparate IT systems and resources.

### BACKGROUND

The subject matter described herein generally relates to service oriented architecture in the context of business combinations.

Changes are continuously happening in enterprises and they impact the IT (Information Technology) landscape. The most drastic changes include mergers and acquisitions, but recent trends like globalization and recession planning also lead companies to adopt new business combination strategies. Mergers and acquisitions are becoming a common practice for large companies to quickly reach new markets or to extend their product portfolio. As part of mergers and acquisitions, very often two or more IT systems need to be combined to meet one or more business objectives, for example reducing IT costs, standardizing business processes or providing a single view to customers. Another trigger of change is globalization, wherein a company may have started with different IT systems due to geo-management expediency, but later wants to use economies of scale to transform itself to a Globally Integrated Enterprise (GIE). Here, it is not uncommon to see combination of many different IT systems.

No matter the exact trigger, such changes may be met by a wide spectrum of IT combination choices, like data center combination, data integration, migration into a single system or uniform business processes implemented by standardized IT. As the scale of combination increases, it promises to provide more cost savings (in terms of support, maintenance, hardware, license(s), training and the like). But increased scale also leads to increased complexity and risk associated with a transformation project.

### BRIEF SUMMARY

Embodiments of the invention broadly contemplate systems and associated methods for a precise characterization of different IT combination strategies that one or more companies can undertake, with a focus on service oriented architecture (SOA) implementations. Embodiments use an explicit model of business to IT dependency and can expose trade-offs in different combination alternatives, thus assisting in making proactive choices regarding business combination of disparate IT systems and resources.

One aspect provides a method comprising: accepting as input one or more business combination scenarios; accessing one or more databases storing: facts regarding two or more information technology systems to be combined according to the one or more business combination scenarios; and one or more rules encoding relationships among the facts; and providing as output one or more information technology combination strategies based on the facts and the one or more rules.

Another aspect provides a computer program product comprising: a computer readable storage medium having computer readable program code embodied therewith, the computer readable program code comprising: computer readable program code configured to accept as input one or more business combination scenarios; computer readable program code configured to access one or more databases storing: facts regarding two or more information technology systems to be combined according to the one or more business combination scenarios; and one or more rules encoding relationships among the facts; and computer readable program code configured to provide as output one or more information technology combination strategies based on the facts and the one or more rules.

A further aspect provides an apparatus comprising: one or more processors; and a memory operatively connected to the one or more processors; wherein, responsive to execution of computer readable program code accessible to the one or more processors, the one or more processors are configured to: accept as input one or more business combination scenarios; access one or more databases storing: facts regarding two or more information technology systems to be combined according to the one or more business combination scenarios; and one or more rules encoding relationships among the facts; and provide as output one or more information technology combination strategies based on the facts and the one or more rules.

The foregoing is a summary and thus may contain simplifications, generalizations, and omissions of detail; consequently, those skilled in the art will appreciate that the summary is illustrative only and is not intended to be in any way limiting. For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates example relationships between combining companies.

FIG. 2 illustrates a Base Model for business-process driven SOA customization.

FIG. 3(A-D) illustrates examples of combination strategies.

FIG. 4 illustrates an example Extended Model for business driven SOA combination.

FIG. 5 illustrates an example method for generating business driven SOA combination strategies and associated impacts.

FIG. 6 illustrates an example computer system.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the claims, but is merely representative of those embodiments.

Reference throughout this specification to “embodiment(s)” (or the like) means that a particular feature, structure, or characteristic described in connection with the embodiment is included in at least one embodiment. Thus, appearances of the phrases “according to embodiments” or “an embodiment” (or the like) in various places throughout this specification are not necessarily all referring to the same embodiment.

Furthermore, the described features, structures, or characteristics may be combined in any suitable manner in one or more embodiments. In the following description, numerous specific details are provided to give a thorough understanding of example embodiments. One skilled in the relevant art will recognize, however, that aspects can be practiced without one or more of the specific details, or with other methods, components, materials, et cetera. In other instances, well-known structures, materials, or operations are not shown or described in detail to avoid obfuscation.

A variety of issues are critical for companies undergoing combination. Herein a company is regarded as any business entity that acts as a separate cost center. A combination is regarded herein as an integration of one or more companies responsive to any triggering factor(s). Thus, no matter what the form of integration, whether it is a merger, an acquisition, a combination of different business units, et cetera, when companies or components thereof are integrated or combined in some way, it is a considered a combination for the purposes of this description. Mergers and acquisitions between two separate companies are used and referred to herein as representative examples of combinations.

Mergers and acquisitions have been discussed in both finance and IT research literature. In these areas, much research has been concentrated on the cultural issues surrounding mergers and acquisitions. Typical works present combination strategies and discuss how to help decision makers in choosing the best strategy based on organizational factors, the size of the company, and Information System factors such as degree of system utilization or personnel skill levels. Although frameworks exist to handle non-technical issues, there is no prior work focusing on IT implementation in the business combination context.

Another related area is how IT systems should be created as a result of combinations, such as mergers and acquisitions. As discussed further herein, one of the main problems is that an IT department is usually not involved during the planning process of mergers and acquisitions. Enterprise Resource Planning (ERP) systems are gaining prominence for IT. Previous works review ERP integration issues in mergers and acquisitions scenarios and argue for more IT research in this space. Outside of ERP, there was no common standard for IT implementation until service oriented architecture (SOA) gained prominence.

In computing, SOA is a flexible set of design principles used during the phases of IT system development and integration. SOA generally defines how to integrate widely disparate applications that may use multiple implementation platforms. The promise of SOA is that not only business users can have a better understanding of the underlying system, but also IT systems can be integrated with reduced efforts.

Previous work has described the impact of SOA on the post-acquisition integration process in specific companies. This work identified multiple challenges including the need to map business processes to SOA components, to change one part of the system and maintain another and to improve transparency of the process.

Moreover, in traditional software engineering, there is some interest in tracking model changes, analysis of generic changes and propagation frameworks. Prior works in this area offer fine-grained rules for both propagation and changes to identify shift in model versions. However, these works do not model business changes and are too low level for use in combination scenarios (these models would result in an unwieldy number of facts (described further herein)). Moreover, the models proposed in these works cannot be used for combination as there is no support for multiple companies (and SOAs) or to represent IT and business combination strategies.

Accordingly, the inventors have recognized that a key problem is what IT combination strategy is best suited for a specific business combination situation or scenario. Quite surprisingly, as described herein, the IT literature is sparse on the topic. For IT implementation and integration, SOA (for example, web services) has emerged as a popular, open-standards based building block. One of the main value drivers for SOA is to assist businesses in becoming more responsive to the changing business environment. However, as companies increase the pace of SOA adoption, there are several unanswered problems regarding how to precisely determine the impact of business combinations on SOA implementations. Some of those problems include for example:
How to combine multiple SOAs resulting from mergers and acquisitions;
How to support decision-makers in cases of combining many (for example ten or more) SOAs, each implementing hundreds of services;
In the pre-combination environment, identifying alternatives available in the IT systems to perform a given business process; and
Identifying differences existing among the alternatives (and in a global company, how to apply a best practice available in a geography to all parts of the company with the minimum impact to existing SOAs).

To answer these types of questions, it can prove useful to focus on how multiple SOAs should be changed for business combination situations. Recent work has discussed alternative models for aligning business process and SOA based IT implementation. Each model can be used to analyze changes in the business domain, either related to business processes or business objects. However, all these models focus on business changes done within a single company and are therefore at best applicable to a single SOA. This is not the case in a combination where the complexity lies for example in combining multiple companies with multiple IT/SOA systems.

In the business combination context, the number of entities involved can be many; with each having hundreds of business processes. For simplicity, consider a very simple situation in which a company, called Company A (Comp-A), wants to combine by acquiring another company, called Company B (Comp-B). Furthermore, let both companies have only two business processes each, Finance and Human Resources (denoted by F_{A}; F_{R} and H_{A}; H_{B}, respectively). Regardless of the reasons for combination of the businesses, the outcome can be that Company A may absorb Company B (called absorption), or keep a symbiotic relationship with Company B that reinforces only their mutual strengths (called symbiosis), or preserve Company B with minimum integration as necessary (called preservation).

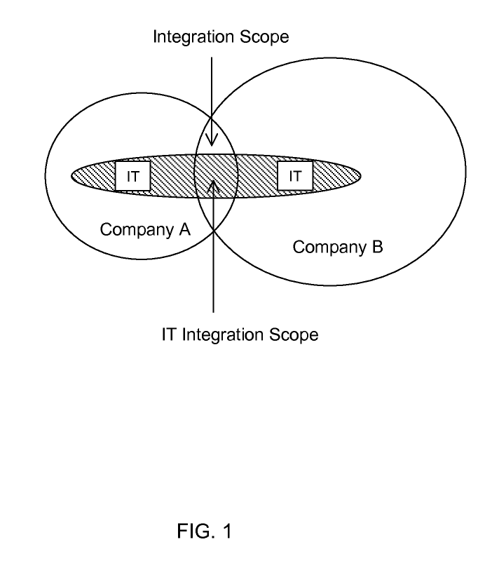

In service of the business strategy, a suitable IT combination strategy should be adopted. The relationship between the combining companies, the scope of integration, and the scope of IT integration are all shown in FIG. 1. For absorption, the possible IT strategies are to discard all pre-existing IT of both merger partners (Company A and Company B) and replace it by a completely new IT (called Renewal). Another strategy is to adopt IT of one of the companies and mandate it over another (called Takeover). Yet another strategy is to take the best elements of IT from both companies and adopt them (called Standardization). For symbiosis, the IT strategy is standardization. For preservation, the IT strategy is to keep IT of both companies and build adapters to exchange information between them (called Synchronization). Example relationships between IT integration strategies and which business combination strategy they apply are summarized in Table I.

TABLE I
IT Combination Strategies Responding to Business Combination Impetus

| | Business | Possible | |
|---|---|---|---|
| IT Combination | Strategy | Resulting IT | Characteristics |
| Renewal | Absorption | F_{*}, H_{*} | No pre-merger IT |
| | | | remains |
| Takeover | Absorption | F_{A}, H_{A} | One pre-merger IT |
| | | | remains |
| Standardization | Absorption, | F_{A}, H_{B} | Best of both are |
| | Symbiosis | F_{A}, H_{*} | preserved, or selectively |
| | | | new introduced |
| Synchronization | Preservation | F_{A}, F_{B} | Both pre-merger IT |
| | | H_{A}, H_{B} | remain |

In the third column, the consequence of the IT strategy and the original IT of the two companies is shown. The combined company may be left with totally new processes, F_{*} and H_{*}, or F_{A} and H_{B} (mixed from previous entities), F_{A} and H_{A} (or vice-versa F_{B} and H_{B}) from one of the two companies, F_{A} and H_{*} (or other combinations between new and existing processes), or all of the previous processes F_{A}; F_{B}; H_{A}; H_{B}.

Consider the case where Company A wants to absorb Company B. The issue for Company A is to decide a SOA combination strategy. The considerations for Company A are to reduce risk of failure due to complexity, while making the integration in a short time, with a low budget and in a way that future integration is not hampered.

Embodiments provide a model that can expose the trade-offs between the SOA combination alternatives and help companies, such as Company A in the example described herein, make an informed decision. The problem may be formulated in the following Problem Statement:
If N companies want to combine, where N≧2, find the implications of 4 alternative IT strategies: Renewal, Takeover, Standardization and Synchronization, on the SOA implementation, post-combination.

Note that a company here is any business entity which acts as a separate cost-center and the company's one or more business processes are implemented with a SOA consisting of one or more services. Typically, the business processes and services number in hundreds or more.

Accordingly, embodiments are configured to use a formalization of the SOA combination problem and solve it with a rigorous decision support framework to reason with the alternatives. Embodiments utilize a model capturing properties and relationships among IT and business elements relevant to the combination process. The model consists of facts and rules. Facts represent claims about the problem universe (for example, systems to be merged) and they may be true or false. Rules encode relationships among facts and are used to infer new facts from the ones in the model. Business or IT combination strategies can be modeled as rules and used by a reasoner to understand the impact of business decisions to the underlying IT systems and vice-versa. An example model is represented using Smodels, an implementation of stable model semantics and well-founded semantics for normal logic programs.

To make the description somewhat self-contained, a review of a previously introduced model (referred to herein as the Base Model) is provided. Further information on the Base Model can be found at: P. Mazzoleni and B. Srivastava, Business driven SOA customization, 6th ICSOC, 2008, pp. 286-301, incorporated by reference here. Then, several enhancements needed to support combination are introduced, namely: new concepts for representing companies and their SOAs, a set of combination rules encoding IT combination choices, and a set of conflict rules to handle potential ambiguities.

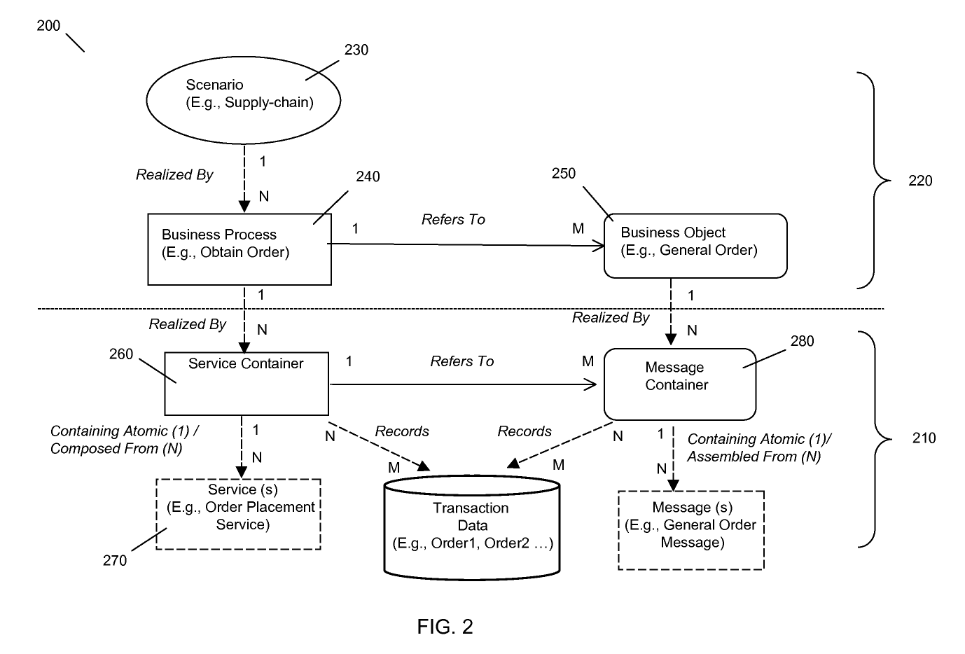

A (simplified) Base Model for SOA customization is illustrated in FIG. 2. The model 200 explicitly separates IT elements 210 from business elements 220 and uses directed arrows to represent dependencies between elements. At the business level 220, an enterprise domain is decomposed into multiple scenarios (for example, scenario 230). Each scenario 230 is realized by one or multiple business processes (BPs) 240 and by one or multiple business objects (BOs) 250. Each BP 240 is defined with business logic and references to BOs 250. Each BO 250 can be referred to by multiple processes as well as by other BOs. At the IT level 210, each BP 240 is realized by a Service Container (SC) 260 referring to one or multiple (Web) service(s) 270.

In case a SC 260 refers to multiple services (due to service composition), it also connects to a logic describing the process flow among those services. In addition, each SC 260 refers to one or multiple Message Containers (MC) 280 describing atomic or aggregate messages that constitute its inputs and outputs. Messages are IT realizations of BOs 250 in specific formats of interest (for example, order information in XML format). Both at IT 210 and business level 220, Structural Rules define dependencies among elements. As an example, bpReferToBO(ShipOrder, Product) structural rule defines that BO Product is used by BO ShipOrder. Similarly, scImplementBP(ShipOrder_ws, ShipOrder) establishes that BP ShipOrder is implemented by SC ShipOrder_ws.

Once the domain has been defined, users can specify Customization Rules to encode customization behaviors of the SOA triggered by new customization requirements (for example, create a new BO for ship order). Similarly, Impact Rules encode the desirable propagation of customization behavior in the model. As an example, changeBusProc(Y): —changeBusLogic(X), bpHasLo(Y,X) rule defines that, if a business logic X changes, the BP using X should change. Given a customization rule, impact rules are used to precisely compute the overall impact of a change spanning both business 220 and IT 210 domains.

It should be noted that in this description, the letters X, Y, K, and Z are used in arguments to refer to variables and others for constants (any letter but X, Y, K and Z that may be used as arguments will refer to constants). Also, to keep notations simple and to a minimum, the facts and rules are concretized to the case of two predefined companies, Company A and Company B. Parameterizing to any number of companies is straightforward.

Embodiments of the invention extend the Base Model described herein. The Base Model was created assuming a single company and a single SOA, and hence the top-level notions of company and its SOA implementation were implicit. For the purpose of combination, an extended model should explicitly introduce Company and SOA so that the combining entities can be referred to unambiguously. Moreover, for the single entity context in which the Base Model arose, there was no need to consider transactional data that a company generates as part of its routine business. However, for combination, seamless access to pre-existing transactional data can be an important consideration. Transactional data refers to data created as part of a company's operations, for example, sales orders executed, products developed, and new customers obtained. Transaction data is a record of a company's operational excellence. When companies merge, the historical transaction data is one of the core components that define worth.

This transactional data results from the services in the company's SOA operating on messages with which they are invoked. Transactional data is now modeled, as for example as illustrated in FIG. 2, and corresponding rules are introduced (TCode). The following are some new model elements and enhancements.

ComplmplementsBP(A,X): List of BP X supported by Comp-A;

CompImplementsBO(A,Y): List of BO Y supported by Comp-A;

CompImplementsSOA(A,Z): List of Service Containers Z part of Comp-A;

SOAHasSc(J,K): List of Service Container K implemented by SOA J;

ScHasTCode(K,P): Service Container K uses Tcode P;

McAHasTCode(Q,P): Message Container Q uses Tcode P.

Now some changes that need to be supported on a modeling element for IT combination are characterized. As a non-limiting example, for migrating a business object (for example, a product), the approach could be creating a data interface (Synchronization) between the implementations done by the companies in the pre-combination scenario. Here, the approach used to propagate the change to others parts of the domain is drastically different from the scenario in which all existing business objects are replaced by new one(s) (Renewal). Once again, the Base Model is extended with the following additional structural rules, describing finer grained type of customizations for the model elements.

Structural Rules—Business Process change type:
BPSunSet(X,A): Comp-A BP X is sunset.
BPMigrate(X,A,B): Comp-A BP X is extended to cover Comp-B implementation.
BPStandardize(X,A,B): A new BP is created to select between Comp-A and Comp-B specifications of BP X.

Structural Rules—Business Object change type:
BOSunSet(X,A): Comp-A BO X is expected to be sunset.
BOMigrate(X,A,B): Replace BO X implementation done in Comp-A and in Comp-B.
BOStandardize(X,A,B): A new BO is created to select between Comp-A and Comp-B specifications of BOX

Structural Rules—Service Container changes type:
CreateSimpleAdapterSc(X,A,B): Create a unidirectional adapter to interface Comp-A and Comp-B implementation of Service Container X.
CreateComplexAdapterSc(X,A,B): Create a bidirectional adapter to interface Comp-A and Comp-B implementation of Service Container X

In addition, two new rules, BOSubSetOfBO(x,A,B) and LogicSubSetOfLogic(x,A,B) are introduced to compare implementations of a business processes (or business objects) done in companies A and B. If the process in A matches or is a subset of the one of B, the function will return True. Otherwise, it will return False. The details on how those functions are implemented are not essential for an understanding of embodiments described herein, as multiple approaches have studied matchmaking algorithms for processes or business objects and those results can be directly applied to the embodiments described herein. See for example: SEMAPLAN: Combining Planning with Semantic Matching to Achieve Web Service Composition, R. Akkiraju, B. Srivastava, A. Ivan, R. Goodwin, T. Mahmood, Proceedings of the IEEE International Conference on Web Services, Chicago (ICWS 2006); and Semantic Matching of Web Services Capabilities, Massimo Paolucci and Takahiro Kawamura and Terry R. Payne and Katia Sycara (2002), available from: http://citeseerx.ist.psu.edu/viewdoc/summary?doi=10.1.1.14.3634, both of which are incorporated by reference here.

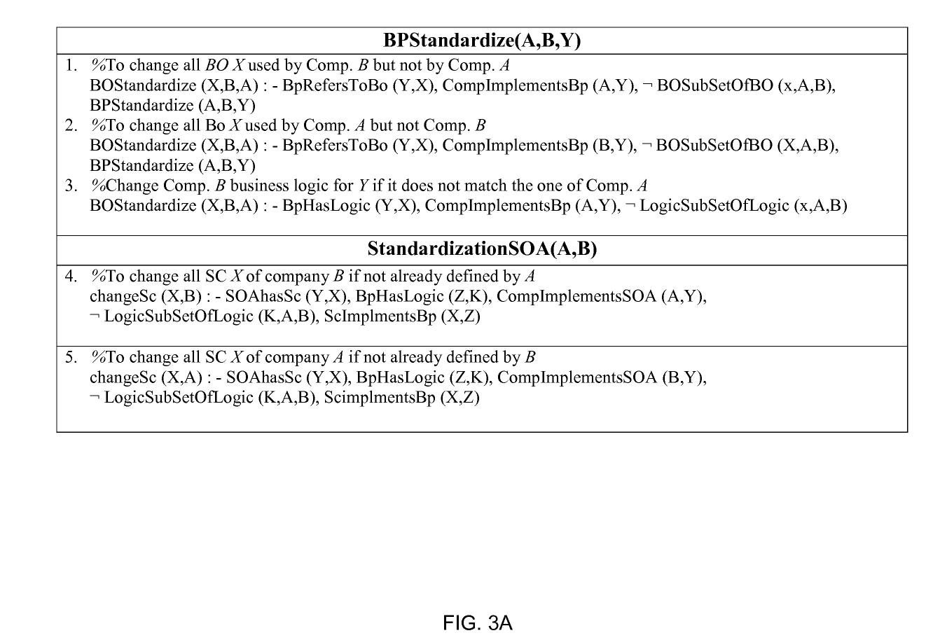

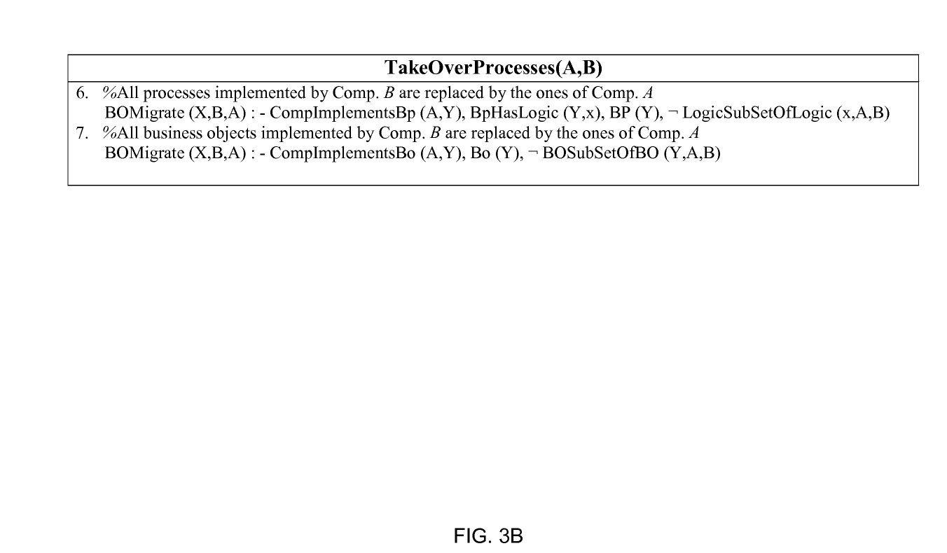

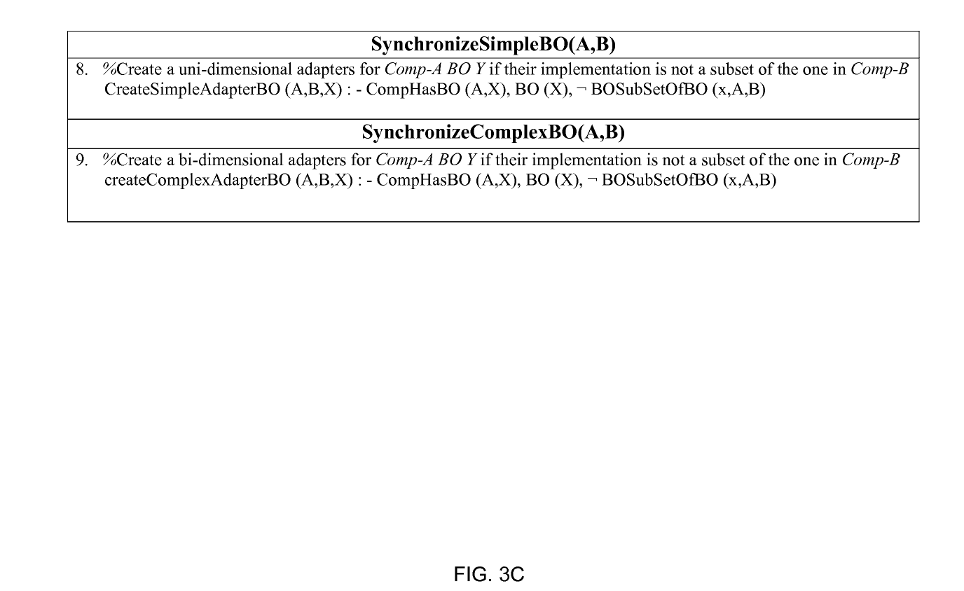

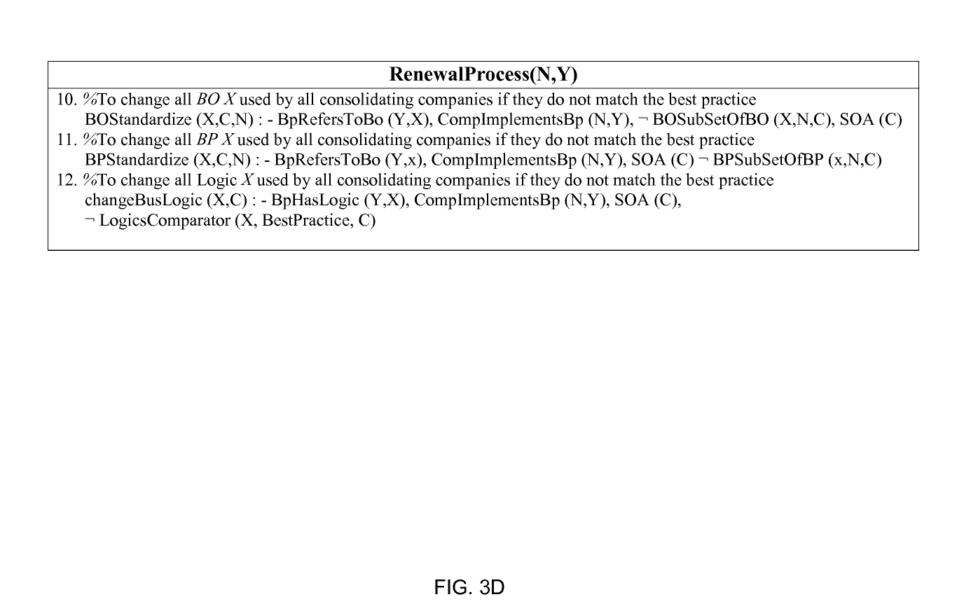

Next are described extensions of the model to encode the different IT implementation strategies. Each strategy is described by means of a Combination Strategy Rule that defines the change. Users participating in combination use such rules to define which strategy should be adopted for which part of the company. Each Combination Strategy Rule is then associated to a set of Impact Rules, examples of which are depicted in FIG. 3(A-D), which identify the impact of the strategy across the various SOAs. A reasoner uses the impact rules to determine the overall impact of a combination strategy rule from business and IT perspective.

Referring generally to FIG. 3A, standardization is the strategy according to which the best elements of both companies are adopted as result of the combination. This approach can impact IT elements, business elements or both.

BPStandardize(A,B): BP adopted in company A and company B are standardized while SOAs remain separated. A typical example is the one in which two companies want to adopt global processes for managing HR but are required to keep their systems separate to comply with legal regulations.

StandardizationSOA(A,B): SOA elements of company B are standardized with the ones of company A but business processes remain separated. This applies in case an SOA is built on an out-dated system or when the company wants to reduce the number of systems to be maintained and upgraded.

Referring generally to FIG. 3B, takeover is a strategy that suggests to completely replace a company's IT systems (SOA) or business processes with the ones of another company. Once again, the strategy might impact business, IT or both.

TakeOverProcesses(A,B): BP adopted in company A replaces the one of company B while SOAs remain separated. A typical example is the one in which a large company acquires a small one to reach new markets. Here, HR processes done in the large company replaces the one of the smaller one.

TakeOverSOA(A,B): SOA B is replaced with SOA A but business processes remain separated. Similar to standardization, this applies for example in case an SOA is built on an out-date system or when the company wants to reduce the number of systems to be maintained and upgraded. However, in case of SOA takeover the primary approach should consist of moving services to the new platform (where possible).

Referring generally to FIG. 3C, in a case of synchronization, interfaces between the IT of the companies are created to enable communication and data exchange.

SynchronizeSimpleBO(A,B): This strategy assumes the creation of adapters to access company A business objects from company B. Note SynchronizationSimpleBO function is not commutative.

SynchronizeComplexBO(A,B): This strategy assumes the creation of adapters to access company A business objects from company B and vice-versa. Note SynchronizationComplexBO function is commutative.

Referring generally to FIG. 3D, renewal as an IT integration mode means that the IT and the business process of both the acquiring and the acquired firms are going to be renewed.

RenewalProcess(A,B): Processes are renewed.

RenewalSOA(A,B): SOAs are renewed. This is the scenario in which a company moves to a new platform and decides to sunset all IT systems and create new ones.

Next are described some conflict rules. Combination strategy rules help users in identifying the overall impact of a business or IT integration strategy as well as comparing different approaches. A model according to embodiments can also help in identifying possible conflicts situations when different strategy approaches are used together in a combination.

Consider once again the scenario discussed in connection with Company A and Company B, and a possible combination strategy in which H_{A} takes over H_{B} while F_{A} and F_{B} are standardized. In this scenario, conflicts might arise for business objects (BOs), message containers (MCs), and service containers (SCs) shared by H and F business processes (BPs). As an example, what is the strategy to be adopted for BOs (for example, Employee) shared by the two processes? Should it be takeover (as Employee is part of HR) or standardization (as Employee is part of Finance)? These (conflict) scenarios are very difficult to discover, especially when more than two SOAs, each with hundreds of services, are integrated.

To address these issues, a new set of rules are introduced and utilized by embodiments. These new rules are referred to herein as Conflict Rules to highlight conflicting conditions generated when different IT combination strategies are used in the same mergers and acquisitions (combination) scenario. Here is an example list of conflict rules for BOs (similar rules can be created for other elements of the model):
Conflict: —BOReplace(X,A,B),
BOReplace(X,B,A), Comp(A), Comp(B)
Conflict: —BOReplace(X,A,B),
BOStandardize(X,A,C), Comp(A), Comp(B), Comp(C)
Conflict: —BOSunSet(X,A),
CreateSimpleAdapterSc(X,A,B), Comp(A), Comp(B)
Conflict: —BOSunSet(X,A),
CreateComplexAdapterSc(X,A,B), Comp(A), Comp(B)

Conflict Rules can be used to identify elements that will require special handling during the migration. A user can leverage these rules to indicate how conflicts should be resolved. As a specific example, a user could specify that in case of conflicts, all BOs should be standardized.

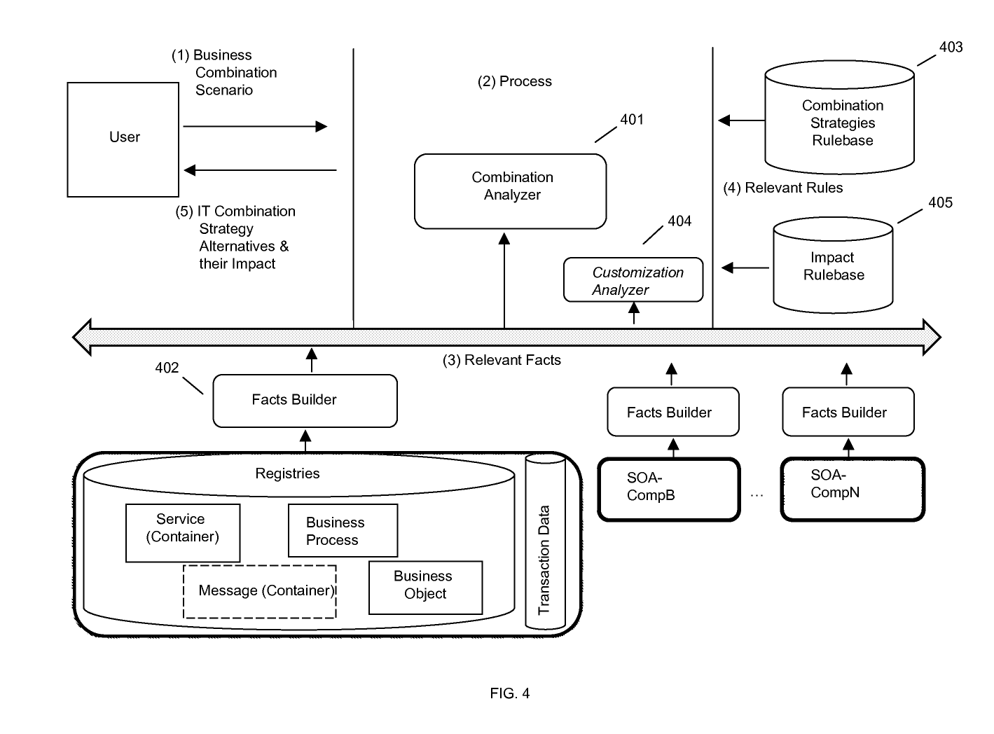

According to embodiments, a system for assessing combination impact includes but is not limited to the architecture shown in FIG. 4. The main components are: a Combination Analyzer module 401 configured to allow a user to control the combination process, a Fact Builder 402 configured to generate logical assertions based on SOA implementation of each company, and a Combination Strategies Rulebase 403 that stores the IT combination rules discussed herein. The system furthermore can also use a Customization Analyzer 404 and Impact Rulebase 405 (as further described in P. Mazzoleni and B. Srivastava, Business driven SOA customization, 6th ICSOC, 2008, pp. 286-301).

Given a business combination scenario the user may be interested in, the Combination Analyzer 401 activates the Fact Builder 402 to model the IT scope, the Rulebases 403, 405 to get the relevant rules directly or through Customization Analyzer 404, and to produce one or more recommendations. Users can now assess, via Combination Analyzer(s) 401, the overall business and IT impacts of a combination scenario prior to implementing it. Users can also compare the impact of different combination rules when applied to different parts of the company. In these situations, conflict rules provide insights on the business or IT elements that will require special consideration.

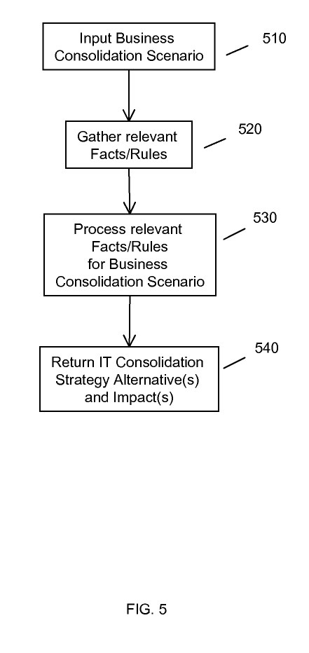

Referring to FIG. 5, an example method of ascertaining business driven SOA combination strategies and associated impacts is illustrated. Input is provided 510 regarding a business combination scenario for two or more companies. The system gathers the relevant facts 520 regarding the companies underlying, original IT systems from a database containing for example facts regarding the SOA of these IT systems. Moreover, the system also obtains the relevant rules for determining the impact of combination on the underlying, original IT systems from a database containing combination strategies rules and impact rules. The system then processes 530 the facts and rules to produce one or more proposed IT combination strategies as well as any alternatives by applying the relevant rules to the relevant facts. Once the processing is complete, the system identifies the impact of the proposed IT combination strategy (and alternatives) on the underlying IT systems and returns 540 the same for the user to review.

The extended model according to embodiments described herein can be used by an assessment tool for business designers and IT developers to support business combination decisions. Apart from impact estimation, embodiments optionally include advance features to support collaboration among teams involved with decisions and to trace costs and business benefits down to each single attribute modified as a result of combination.

Some advanced features of embodiments are as follows. Embodiments described herein can be used beyond impact assessment. Specifically, embodiments can support project managers and teams working on complex combination scenarios with more than two companies and/or dozens of IT systems. Those scenarios are very common in practice and can involve hundreds of consultants analyzing business processes and providing inputs on combination.

For example, one activity is for consultants to design the combined business process flows. Current business process management tools enable collaborative editing of process flows, but do not help users in understanding how their changes will impact other teams. Moreover, project managers do not have any visibility on how the combination strategy decided at company-level is adopted by consultants re-designing the process flows. Consider for example a user that decides to standardize a business object despite the company advocating a takeover. Implemented as an extension of an existing business process management tool, the solutions described herein can dynamically collect changes done by single team(s) and, given the impact rules, propagate those to other team(s), as well as to project managers. Through an integrated dashboard, a project manager can now monitor which combination decisions have been made in different parts of the business, and drill-down to the specific business or IT element modified by a single user.

A second example activity that can benefit from such an approach is the smoothing of IT culture conflicts (such as human concerns) in combination processes. Here, structural and impact rules can be annotated with different human factor(s) (metrics) information (for example, how likely a user is willing to have his/her decision reviewed, who is the decision maker of a business area, et cetera). Collected as part of propagation decisions, such information can then be used as input for frameworks that help in assessing non-technical aspects of the combination.

Moreover, a user can associate cost information to each element (and rule) of the model. The model can be further extended to include a different weight for each company, business process(es) or system(s). For example, the cost of maintaining an unsupported system is higher than maintaining a supported one. Each time a user makes a combination (or suggests a combination) decision, the system will compute the estimated cost and share it both to project team-members and project managers.

How the scale of the combination model changes with different IT integration strategies is now described. In previous work, estimation of the scale of customization needed due to a business change was accomplished via estimating the number of model elements (for example, BP, BO, SC, MC) impacted. Herein, a similar approach is utilized, and the scale of change implied by an IT combination strategy is estimated by estimating the number of facts and rules needed to reason for each IT integration strategy.

Table II shows an estimate of the size (scale) of a combination model for business level entities. Since the relation between business level to SOA (IT) level elements is already captured in the Base Model, described herein, and all the changes are coming from the business context, all SOA level changes are covered. During a renewal, since a new IT system takes shape, the business processes and objects are equal to the minimum (or at the scale of minimum) number of pre-existing entities. In a takeover, the complexity of the acquirer prevails. In a standardization, since the business process may be selected from either of the two companies, the maximum of the two can prevail in the worst case. In a synchronization, the complexities of both companies remain, along with additional ones for the new adapters that need to be developed. The complexity of the adapters (A) is a function of existing BOs and BPs.

From the estimate, the following key insights about combination can be drawn:
In post-combination IT scenario, the #BOs and #BPs grows linearly with the number of companies for all strategies except synchronization, for which it grows exponentially.
Before combination, all BOs and BPs in the companies need to be analyzed to know the scope of the merger. Hence, the complexity of the companies (in terms of #BOs and #BPs from both companies) cannot be ignored regardless of the IT strategy.
As renewal seeks to re-do the IT implementation, it would try to have minimum number of BOs and BPs. On the other hand, in standardization, the aim is to seek common BOs and BPs from the two implementations to minimize surprises and not loose any existing functionality. So, maximum is the upper limit.
#BOs and #BPs is expected to be minimum post-merger in renewal, followed by takeover, then standardization and maximum in synchronization.

TABLE II
Estimated Maximum (éù) Number of Facts and Structural Rules for Business
Level Entities.

| IT Integration | | | | |
|---|---|---|---|---|
| Type | Element | # Facts | # Structural Rules | Description |
| Renewal | BO | N_{BO}^{x} = min(N_{BO}^{A}, N_{BO}^{B}) | ((N_{BO}^{x} * (N_{BO}^{x} − 1))/2) | BOs is in the order |
| | | | | of BOs of |
| | | | | minimum in the |
| | | | | two companies. |
| Renewal | BP | 2 * N_{BP}^{x}; | ((N_{BP}^{x} * (N_{BP}^{x} − 1))/2) + N_{BP}^{x} | BPs is in the order |
| | | N_{BP}^{x} = min(N_{BP}^{A}, N_{BP}^{B}) | | of BPs of |
| | | | | minimum in the |
| | | | | two companies. |
| Takeover | BO | N_{BO}^{A} | ((N_{BO}^{A} * (N_{BO}^{A} − 1))/2) | BOs of A remain |
| Takeover | BP | 2 * N_{BP}^{A} | ((N_{BP}^{A} * (N_{BP}^{A} − 1))/2) + N_{BP}^{A} | BPs of A remain |
| Standardization | BO | N_{BO}^{x} = max(N_{BO}^{A}, N_{BO}^{B}) | ((N_{BO}^{x} * (N_{BO}^{x} − 1))/2) | BOs common to |
| | | | | both companies, |
| | | | | and unique to |
| | | | | either remain |
| Standardization | BP | 2 * N_{BP}^{x}; | ((N_{BP}^{x} * (N_{BP}^{x} − 1))/2) + N_{BP}^{x} | BPs common to |
| | | N_{BP}^{x} = max(N_{BP}^{A}, N_{BP}^{B}) | | both companies, |
| | | | | and unique to |
| | | | | either remain. |
| Synchronization | BO | N_{BO}^{x} = N_{BO}^{A} + N_{BO}^{B} + | ((N_{BO}^{x} * (N_{BO}^{x} − 1))/2) | BOs of both |
| | | Δ(N_{BO}^{A}, N_{BO}^{B}) | | companies and |
| | | | | additional for |
| | | | | adapters |
| | | | | integrating BOs. |
| Synchronization | BP | 2 * N_{BP}^{x}; N_{BP}^{x} + N_{BP}^{A} + | ((N_{BP}^{x} * (N_{BP}^{x} − 1))/2) | BPs of both |
| | | N_{BP}^{B} + Δ(N_{BP}^{A}, N_{BP}^{B}) | | companies and |
| | | | | additional for |
| | | | | adapters |
| | | | | integrating BPs. |

In summary, the preferred IT strategies in the order of complexity are: renewal, takeover, standardization and synchronization. This does not mean all companies would always choose the first strategy (renewal). A company may consider renewal risky while takeover has the advantage of continuity since business (and IT) running at least one of the companies prevail. A further risk averse company that holds cost secondary may even choose synchronization as its IT strategy since there is no SOA impact to any of the companies.

As the number of companies increase beyond two, there is an exponential increase in the possible relationship between BOs, BPs and the IT elements. This will get reflected in the size of the factbase. Now renewal starts becoming attractive while even takeover becomes too large and synchronization is impractical. In fact, renewal was the IT implementation in a large company's actual combination project with 20 different IT implementations being involved.

Accordingly, embodiments address a pressing problem in enterprises that need to re-organize due to merger, acquisition, or other business combination strategies and consequently, must combine IT. Typically, IT combination is taken on reactively, for example only after the mergers and acquisitions decisions have been made, rather than proactively at the very outset. Although an IT combination strategy is not necessary for the success of merger, a successful IT combination helps the acquirer to realize the full value of the business combination. Embodiments provide a precise method to characterize the different IT combination strategies that a company can undertake with a focus on SOA implementation. The embodiments described herein use an explicit model of business to IT dependency and can expose the trade-offs in different alternatives. An example system implementing the approaches has been described herein and example methods described how to draw guidance for some business combination scenarios.

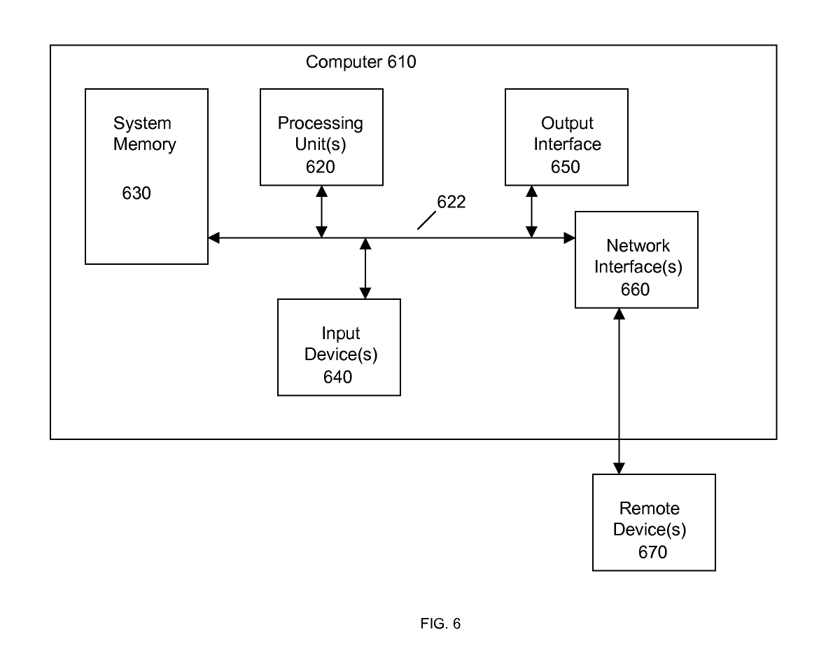

Referring to FIG. 6, it will be readily understood that embodiments can be implemented using any of a wide variety of devices or combinations of devices. An example device that may be used in implementing one or more embodiments includes a computing device in the form of a computer 610. In this regard, the computer 610 may execute program instructions configured to implement a business combination scenario tool, process queries relating to proposed IT combination strategies, and perform other functionality of the embodiments, as described herein.

Components of computer 610 may include, but are not limited to, a processing unit 620, a system memory 630, and a system bus 622 that couples various system components including the system memory 630 to the processing unit 620. Computer 610 may include or have access to a variety of computer readable media. The system memory 630 may include computer readable storage media in the form of volatile and/or nonvolatile memory such as read only memory (ROM) and/or random access memory (RAM). By way of example, and not limitation, system memory 630 may also include an operating system, application programs, other program modules, and program data.

A user can interface with (for example, enter commands and information) the computer 610 through input devices 640. A monitor or other type of device can also be connected to the system bus 622 via an interface, such as an output interface 650. In addition to a monitor, computers may also include other peripheral output devices. The computer 610 may operate in a networked or distributed environment using logical connections to one or more other remote computers or databases, such as databases storing IT system information or combination strategies and/or impact rules. The logical connections may include a network, such local area network (LAN) or a wide area network (WAN), but may also include other networks/buses.

It should be noted as well that certain embodiments may be implemented as a system, method or computer program product. Accordingly, aspects of the invention may take the form of an entirely hardware embodiment, an entirely software embodiment (including firmware, resident software, micro-code, et cetera) or an embodiment combining software and hardware aspects that may all generally be referred to herein as a “circuit,” “module” or “system.” Furthermore, aspects of the invention may take the form of a computer program product embodied in one or more computer readable medium(s) having computer readable program code embodied therewith.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, et cetera, or any suitable combination of the foregoing.

Computer program code for carrying out operations for aspects of the invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described herein with reference to flowchart illustrations and/or block diagrams of methods, apparatuses (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Although illustrated example embodiments have been described herein with reference to the accompanying drawings, it is to be understood that embodiments are not limited to those precise example embodiments, and that various other changes and modifications may be affected therein by one skilled in the art without departing from the scope or spirit of the disclosure.

What is claimed is:

1. A method comprising:
accepting as input one or more business combination scenarios;
accessing one or more databases storing:
facts regarding two or more existing information technology systems to be combined according to the one or more business combination scenarios; and
one or more rules encoding relationships among the facts; and
providing as output one or more information technology combination strategies based on the facts and the one or more rules.

2. The method according to claim 1, wherein the facts further comprise a set of claims regarding one or more company specific service oriented architectures.

3. The method according to claim 2, wherein the one or more rules comprise one or more combination strategy rules defining one or more combination strategies.

4. The method according to claim 3, wherein each combination strategy rule is associated to a set of impact rules identifying one or more impacts of the one or more combination strategies across service oriented architectures.

5. The method according to claim 4, wherein providing as output one or more information technology combination strategies based on the facts and the one or more rules further comprises:
utilizing a reasoner to access the set of impact rules to determine an overall impact of a combination strategy rule from business and information technology perspectives.

6. The method according to claim 1, wherein the one or more information technology combination strategies comprise one or more of:
standardize, wherein elements of the two or more existing information technology systems are adopted;
takeover, wherein a complete replacement of one of the two or more existing information technology systems is adopted;
synchronize, wherein interfaces between the two or more existing information technology systems are created to enable communication and data exchange there-between; and
renewal, wherein the two or more existing information technology systems are renewed.

7. The method according to claim 6, wherein the one or more information technology combination strategies include two or more different information technology combination strategies for a given input business combination scenario.

8. The method according to claim 7, wherein the one or more rules further comprise one or more conflict rules configured to highlight conflicting conditions generated when the two or more different information technology combination strategies are used for the given input business combination scenario.

9. The method according to claim 1, wherein providing as output one or more information technology combination strategies further comprises providing combination impact information regarding non-technical aspects of the one or more business combination scenarios.

10. A computer program product comprising:
a computer readable storage medium having computer readable program code embodied therewith, the computer readable program code comprising:
computer readable program code configured to accept as input one or more business combination scenarios;
computer readable program code configured to access one or more databases storing:
facts regarding two or more existing information technology systems to be combined according to the one or more business combination scenarios; and
one or more rules encoding relationships among the facts; and
computer readable program code configured to provide as output one or more information technology combination strategies based on the facts and the one or more rules.

11. The computer program product according to claim 10, wherein the facts further comprise a set of claims regarding one or more company specific service oriented architectures.

12. The computer program product according to claim 11, wherein the one or more rules comprise one or more combination strategy rules defining one or more combination strategies.

13. The computer program product according to claim 12, wherein each combination strategy rule is associated to a set of impact rules identifying one or more impacts of the one or more combination strategies across service oriented architectures.

14. The computer program product according to claim 13, wherein the computer readable program code further comprises computer readable program code configured to utilize a reasoner to access the set of impact rules to determine an overall impact of a combination strategy rule from business and information technology perspectives.

15. The computer program product according to claim 10, wherein the one or more information technology combination strategies comprise one or more of:
standardize, wherein elements of the two or more existing information technology systems are adopted;
takeover, wherein a complete replacement of one of the two or more existing information technology systems is adopted;
synchronize, wherein interfaces between the two or more existing information technology systems are created to enable communication and data exchange there-between; and
renewal, wherein the two or more existing information technology systems are renewed.

16. The computer program product according to claim 15, wherein the one or more information technology combination strategies include two or more different information technology combination strategies for a given input business combination scenario.

17. The computer program product according to claim 16, wherein the one or more rules further comprise one or more conflict rules configured to highlight conflicting conditions generated when the two or more different information technology combination strategies are used for the given input business combination scenario.

18. The computer program product according to claim 17, wherein the computer readable program code further comprises computer readable program code configured to provide combination impact information regarding non-technical aspects of the one or more business combination scenarios.

19. An apparatus comprising:
one or more processors; and
a memory operatively connected to the one or more processors;
wherein, responsive to execution of computer readable program code accessible to the one or more processors, the one or more processors are configured to:
accept as input one or more business combination scenarios;
access one or more databases storing:
facts regarding two or more existing information technology systems to be combined according to the one or more business combination scenarios; and
one or more rules encoding relationships among the facts; and
provide as output one or more information technology combination strategies based on the facts and the one or more rules.

20. The apparatus according to claim 19, wherein the facts further comprise a set of claims regarding one or more company specific service oriented architectures; and wherein the one or more rules comprise one or more combination strategy rules defining one or more combination strategies.
